(19) United States
(12) Patent Application Publication
(10) Pub. No.: US 2026/0221878 A1
(43) Pub. Date: Jul. 30, 2026

(54) Control of field-effect transistors of a power converter

(71) Applicant: SIGNIFY HOLDING B.V., EINDHOVEN (NL)

(72) Inventor: REINHOLD ELFERICH, AACHEN (DE)

(21) Appl. No.: 19/147,497

(22) PCT Filed: Jan. 9, 2024
(86) PCT No.: PCT/EP2024/050356

§ 371 Date: Jul. 11, 2025

(30) Foreign Application Priority Data
Jan. 12, 2023 (EP) 23151232.8

(51) Int. Cl. H02M 3/158; H02M 1/00; H02M 1/38; H05B 47/10

(52) U.S. Cl. CPC H02M 3/158; H02M 1/0058; H02M 1/38; H05B 47/10

(57) ABSTRACT

A mechanism for controlling the operation of a pair of transistors in a power converter. The length of one or more deadtimes in controlling the operation of the transistor is controlled responsive to a first sensing signal. The first sensing signal is itself responsive to an average or cumulative length of time that one or both transistors undergo reverse conduction when controlled to be in an off-state.

### FIELD OF THE INVENTION

The present invention relates to the area of field-effect transistors.

### BACKGROUND OF THE INVENTION

There is an increasing interest in power converters that make use of a pair of synchronously controlled switches. In such power converters, one of the switches, such as a field-effect transistor, takes the place of a traditional diode of the power converter, the operation of the diode-replacing switch is controlled such that it permitted to conduct current during occasions (of a control approach) that the diode would otherwise conduct current.

Generally, in such power converters, a primary switch (being a power controlling switch that controls a power flow from a power source to a load) for the power converter is paired with a diode-replacing switch. The diode-replacing switch is controlled synchronously so that it does not conduct current at the same time as the primary switch. Synchronously controlled switches can be commonly found in half- or full-bridge inverters for a power converter.

Zero-voltage switching is of increasing interest in such power converters to reduce power consumption. In zero-voltage switching, a deadtime is introduced between switching one of the primary switch and diode-replacing switch off, and switching the other of the primary switch and diode-replacing switch on. This reduces a voltage difference across each switch when they change state, significantly reducing a power consumption.

Approaches or circuits that facilitate improvements in the control of a power converter that employs a zero-voltage switching technique are desired.

### SUMMARY OF THE INVENTION

The invention is defined by the claims.

According to examples in accordance with an aspect of the invention, there is provided a control system for a power converter comprising a first and second field-effect transistor to be synchronously controlled.

The control system is configured to: control the switching of the first and second field-effect transistors according to an iteratively repeated sequence comprising: a first period of time, during which the first field-effect transistor is on, and the second field-effect transistor is off; a second period of time, during which the first field-effect transistor is off, and the second field-effect transistor is off; a third period of time, during which the first field-effect transistor is off, and the second field-effect transistor is on; and a fourth period of time during which the first field-effect transistor is off, and the second field-effect transistor is off.

The control system is also configured to receive a first sensing signal, being a sensing signal that changes responsive to an average or cumulative length of time that the first or second field-effect transistor conducts when off during a plurality of iterations of the iteratively repeated sequence; and modify the length of the second and/or fourth period of time responsive to the first sensing signal.

The present disclosure thereby provides a mechanism for using an average or cumulative length of time that a first and/or second field-effect transistor undergoes reverse conduction to control the length of deadtime between switching one of the first/second field-effect transistors off and switching the other of the first/second field-effect transistors on.

This approach allows for tuning of this deadtime to reduce a risk of hard-switching of the first and/or second field-effect transistors. This approach thereby reduces power loss in the power converter.

The control system may be configured to decrease the length of the second and/or fourth period of time responsive to the first sensing signal indicating that the average or cumulative length of time, that the first or second field-effect transistor conducts when off, is more than a first predetermined length of time.

The control system may be configured to increase the length of the second and/or fourth period of time responsive to the first sensing signal indicating that the average or cumulative length of time, that the first or second field-effect transistor conducts when off, is less than a second predetermined length of time. The first and second predetermined lengths of time may be different.

In some examples, the first sensing signal is a sensing signal that changes responsive to an average or cumulative length of time that the first field-effect transistor conducts when off during a plurality of iterations of the iteratively repeated sequence; the iteratively repeated sequence comprises, during the fourth period of time modulating the length of the fourth period of time according to a modulation pattern; and the control system is further configured to perform a demodulation procedure on the first sensing signal to determine whether or not the first sensing signal carries the modulation pattern; and control the total length of the iteratively repeated sequence responsive to whether or not the demodulation procedure determines that the first sensing signal carries the modulation pattern.

This technique provides an approach for monitoring or detecting whether hard-switching is occurring by modulation of the deadtime. This approach makes use of the circuitry used for producing the first sensing signal, thereby avoiding the need for additional sensing circuitry.

The control system may be configured to decrease the total length of the iteratively repeated sequence responsive to the demodulation procedure determining that the first sensing signal carries the modulation signal. This approach effectively increases the reactive current in the power converter. It is recognized that a reactive current that is too small can result in hard-switching.

The control system may be configured to increase the total length of the iteratively repeated sequence responsive to the demodulation procedure determining that the first sensing signal does not carry the modulation signal. It is desirable to reduce reactive current in the power converter when possible, to improve the power efficiency of the power converter. If hard-switching is not detected, then reactive current can be safely reduced.

In some embodiments, the first sensing signal is a sensing signal that changes responsive to an average or cumulative length of time that the first field-effect transistor is conducting, when off, during a plurality of iterations of the iteratively repeated sequence; and the control system is configured to modify the length of the second period of time responsive to the first sensing signal.

In some examples, the control system is further configured to: receive a second sensing signal, being a sensing signal that changes responsive to an average or cumulative length of time that the second field-effect transistor is conducting, when off, during a plurality of iterations of the iteratively repeated sequence; and the control system is configured to modify the length of the fourth period of time responsive to the second sensing signal.

Thus, separate control signals can be used to control the second and fourth periods of time independently. This allows for more precise control over the operation or switching of the first and second field-effect transistors, e.g., to account for manufacturing differences, differences in operation efficiency (e.g., due to electron injection) or the like.

The control system may be further configured to: receive a third sensing signal, being a sensing signal that changes responsive to an average or cumulative size of any voltage steps that occur during switching of the first or second field-effect transistor from off to on or from on to off throughout a plurality of iterations of the iteratively repeated sequence; and modify the total length of the iteratively repeated sequence responsive to the third sensing signal.

Thus, a dedicated hard-switching sensing signal may be generated and used to control the length of the iteratively repeated sequence.

In some examples, the control system is configured to decrease the total length of the iteratively repeated sequence responsive to the third sensing signal indicating that the average or cumulative size is less than a first value during the plurality of iterations of the iteratively repeated sequence.

The control system may be configured to increase the total length of the iteratively repeated sequence responsive to the third sensing signal indicating that the average or cumulative size is more than a second value during the plurality of iterations of the iteratively repeated sequence. The first and second values may be different for hysteric control.

There is also proposed a sensing circuit for determining an average or cumulative length of time that a field-effect transistor is conducting when off, the field-effect transistor being coupled between a first voltage level and an FET node.

The sensing circuit comprising: a first input node configured to connect to the first voltage level; a second input node configured to connect to the FET node; a third input node configured to connect to a reference voltage level; an output node for providing a first sensing signal for indicating the average or cumulative length of time that the field-effect transistor is conducting when off; a transistor, comprising a base, emitter and collector; one or more diodes, connected in series and coupled between the emitter and the second input node, wherein a magnitude of a voltage drop across the one or more diodes is less than a magnitude of a gate threshold of the field-effect transistor; and an filtering circuit coupled between the collector of the transistor and the output node and configured to generate the first sensing signal by averaging and/or filtering the signal at the collector of the transistor.

Previous embodiments provide control systems that make use of a sensing signal. This approach provides an embodiment of a sensing circuit for generating/producing a suitable sensing signal. The sensing circuit and control system are considered to form a group of inventions that share the same general concept, namely that a first sensing signal that indicates the average or cumulative length of time that the field-effect transistor is conducting when off can be used to advantage. Put another way, they correspond to interrelated features.

In some examples, the predefined voltage level is a high voltage level; and the transistor is a PNP transistor.

In some examples, each of the one or more diodes is connected so that current is able to flow from the second input node to the emitter.

In some examples, the filtering circuit is configured to integrate the signal at the collector of the transistor to produce an integrated signal and average the integrated signal to produce the first sensing signal.

The predefined voltage level may be a low voltage level; and the transistor may be an NPN transistor. In this approach, each of the one or more diodes may be connected so that current is able to flow from the emitter to the second input node.

The sensing circuit may further comprise a capacitor connected between the emitter and the third input node.

In an example, a lighting system is provided. The lighting system comprises:
a power converter;
a control circuit according to any of the preceding claims for controlling the power converter;
a lighting load, arranged to receive power from the power converter.

A lighting system may be provided with an improved power converter that allows the operating at relatively high frequencies with an alleviated requirement for the processing power of the control circuit.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 illustrates a power converter in which embodiments can be employed;

FIG. 2 illustrates a basic control sequence for controlling the transistors of the power converter;

FIG. 3 illustrates waveforms for various nodes of the power converter;

FIG. 4 illustrates the effect of a deadtime being too short;

FIG. 5 illustrates the effect of a deadtime being too long;

FIG. 6 illustrates a sensing circuit for monitoring a reverse conduction of a transistor;

FIG. 7 illustrates an alternative sensing circuit for monitoring a reverse conduction of a transistor;

FIG. 8 illustrates potential outputs of a sensing circuit for different deadtimes;

FIG. 9 illustrates control logic for use in an embodiment;

FIG. 10 illustrates the effect of a reactive current in the power converter being too small;

FIG. 11 illustrates alternative control logic for use in an embodiment;

FIG. 12 illustrates a sensing circuit for monitoring hard-switching;

FIG. 13 illustrates an alternative sensing circuit for monitoring hard-switching; and

FIG. 14 provides an overview of a proposed control strategy

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a mechanism for controlling the operation of a pair of transistors in a power converter. The length of one or more deadtimes in controlling the operation of the transistor is controlled responsive to a first sensing signal. The first sensing signal is itself responsive to an average or cumulative length of time that one or both transistors undergo reverse conduction when controlled to be in an off-state.

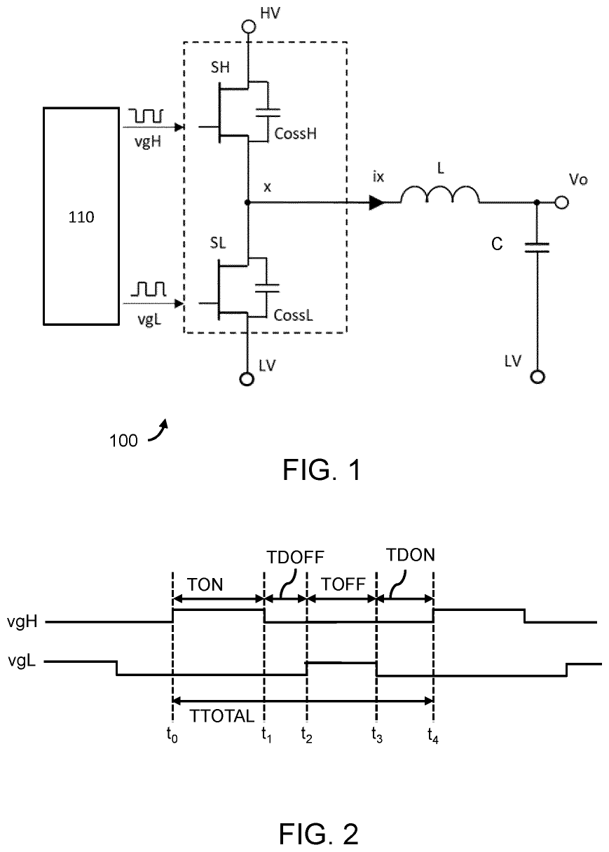

FIG. 1 illustrates a power converter 100, for improved contextual understanding. The illustrated power converter is a buck converter, although modifications to this approach will be apparent (e.g., to provide a boost or buck-boost converter).

The illustrated power converter is configured to control a power provided to an output node Vo, by controlling the power flow ix through an inductor L and across a capacitor C. The voltage across the capacitor C defines the voltage at the output node Vo.

The power converter 100 comprises a first field-effect transistor (first FET) SH and a second field-effect transistor (second FET) SL. The first field-effect transistor SH is connected between a first voltage level HV (e.g., a high voltage level) and an FET node x. The second field-effect transistor is coupled between a second voltage level LV (e.g., a low voltage level) and the FET node x.

The first field-effect transistor SH thereby acts as a primary switch or power switch, it that is controls the power flow from a power source (the first voltage level HV) and the load. The second field-effect transistor SL acts as the diode-replacing switch.

A control system 110 controls the operation of the first SH and second SL field-effect transistors. This can be controlled using appropriate control signals vgH, vgL. A first control signal vgH controls the operation of the first FET SH and a second control signal vgL controls the operation of the second FET SL.

In particular, the control system 110 is able to control the first field-effect transistor to switch between an on-state (or simply “on”), in which current is permitted to flow from the first voltage level HV to the FET node or vice versa, and an off-state (or simply “off”) in which the flow of current from the first voltage level HV to the FET node x is restricted.

Similarly, the control system 110 is able to control the second field-effect transistor to switch between an on-state (or simply “on”), in which current is permitted to flow from the FET node x to the second voltage level LV or vice versa and an off-state (or simply “off”) in which the flow of current from the FET node to the second voltage level LV is restricted.

Reverse conduction (in the off-state) is possible due to the presence of a body-diode in a MOSFET or the diode-like behavior of other FETs, such as the GaN FET (which causes conduction during third quadrant operation). This reverse conduction in an off-state is therefore usually considered an intrinsic feature of field-effect transistors.

The general approach adopted by the control system 110 follows well-established principles. In particular, the control system 110 is configured to control the on/off state of the first SH and second SL field-effect transistors to control the power provided to the output node Vo. Generally, the control by the control system 110 is such that the first SH and second SL field-effect transistors are not switched on at a same time (to avoid power loss).

FIG. 2 illustrates a basic control sequence for the first and second field-effect transistors, which basic control sequence is performed by the control system 110.

As previously explained, control over whether the first SH or second SL field-effect transistor is on or off is controlled by the control signals vgH, vgL. For the purposes of this Figure, a higher value for each control signal indicates that the corresponding field-effect transistor is on, with a lower value indicating that the corresponding field-effect transistor if off (i.e., the FETs are N-channel FETs). Of course, this may be inverted if, for instance, the field-effect transistors are P-channel FETs. Only two possible values (i.e., binary values) for each control signal are illustrated in this Figure for contextual understanding.

For the remainder of this description, it shall be assumed that the field-effect transistors are N-channel FETs. The skilled person would be capable of modifying or adapting any hereafter described approach for use with P-channel FETs (or a mix of an N-channel FET and a P-channel FET).

To provide a desired power at the output node, the control system may iteratively repeat a sequence comprising: a first period of time (t₀-t₁), during which the first field-effect transistor is on (i.e., vgH is high), and the second field-effect transistor is off (i.e., vgL is low); a second period of time (t₁-t₂), during which the first field-effect transistor is off, and the second field-effect transistor is off; a third period of time (t₂-t₃), during which the first field-effect transistor is off, and the second field-effect transistor is on; and a fourth period (t₃-t₄) of time during which the first field-effect transistor is off, and the second field-effect transistor is off.

The control system may begin with the first period of time, moving to the second period of time, moving to the third period of time and then moving to the fourth period of time, after which the sequence repeats.

This sequence can be labelled the basic switching sequence for the purposes of this disclosure. The basic switching sequence is iteratively cycled or repeated. As the basic control sequence is iteratively repeated, it can also be referred to as an iteratively repeated sequence.

The length of the first period of time t₀-t₁ can be labelled TON, the length of the second period of time t₁-t₂ can be labelled TDOFF, the length of the third period of time t₂-t₃ can be labelled TOFF and the length of the fourth period of time t₃-t₄ can be labelled TDON. The total length of the control sequence t₀-t₄ can be labelled TTOTAL.

The second t₁-t₂ and fourth t₃-t₄ periods of time act as deadtime, as they represent periods during which neither the first nor the second field-effect transistor is controlled to be in an on-state. The purpose of the deadtime is to reduce a voltage difference across each transistor when they change state by allowing any voltage at the FET node to drain away or recharge, significantly reducing a power consumption. This is with the intent of achieving zero-voltage switching.

For the sake of illustrative clarity, non-ideal effects (such as any voltage ramping) are not illustrated in FIG. 2.

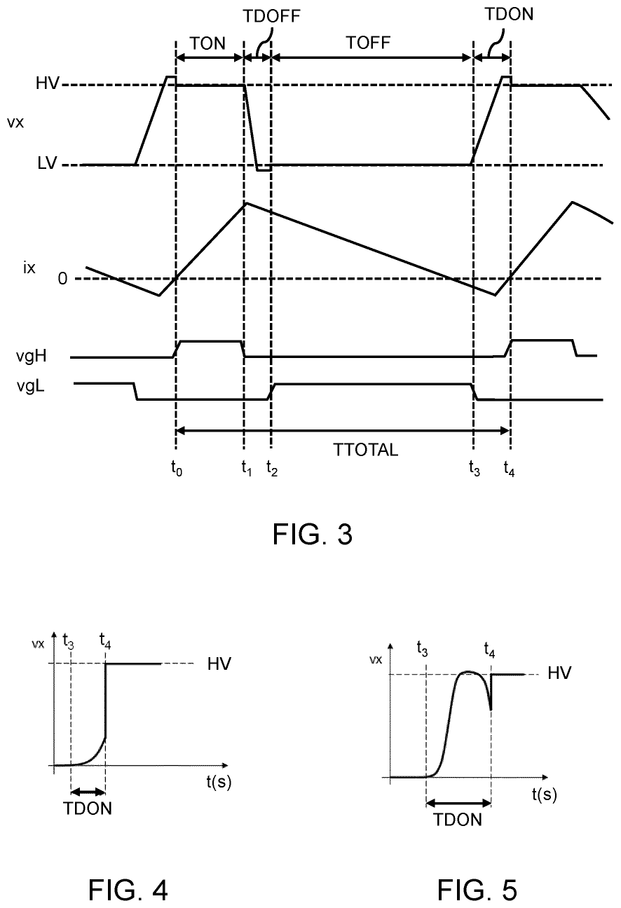

FIG. 3 illustrates the same basic control sequence, as well as the resultant waveforms that result from controlling the power converter according to the basic control sequence. A number of non-ideal effects (e.g., ramping performed when switching from a low to a high voltage) are also indicated where appropriate.

More particularly, FIG. 3 illustrates the waveforms of the voltage vx and the current ix at the FET node. This defines the power provided to the load.

In existing control schemes that make use of the basic control sequence previously described, the length TON of the first time period t₀-t₁ is controlled in order to achieve a desired output power (e.g., a desired output voltage and/or current). The greater the length of TON relative to the overall length TTOTAL of the basic control sequence, the more power is supplied to the converter for conversion. The ratio between the length of TON and the overall length TTOTAL is commonly referred to as a duty cycle D. Increasing D increases the power supplied to the converter for conversion.

The present invention relates to a technique that modifies or builds upon the basis control sequence previously provided. In particular, proposed techniques define or control the length of one or more periods of time within the basic control sequence in order to control one or more characteristics of the converter, particularly characteristics that affect the power consumption by the power converter.

Firstly, it is recognized that during the second and fourth periods of time, i.e., during the deadtime, energy can be lost through reverse conduction of one or both of the field-effect transistors. This significantly affects the power efficiency of the overall power converter. Thus, it would be preferable to reduce or minimize the length TDOFF of the second period of time t₁-t₂ as well as the length TDON of fourth period of time t₃-t₄.

However, it has also been recognized that if the lengths TDOFF, TDON of these periods of time are too low, then the voltage at the FET node x will not yet have reached the voltage level to which it will be switched or connected to by the first/second field-effect transistor switching on. For instance, if the fourth period of time t₃-t₄ is too short, then the voltage vx at the FET node x will not yet have charged so as to reach the high voltage level HV before the first field-effect transistor is switched on (i.e., the first control signal vgH goes high). A similar result occurs if the second period of time is too short. More particularly, the voltage vx at the FET node x will not yet have discharged so as to reach the low voltage level LV before the second field-effect transistor is switched on (i.e., the second control signal vgH goes high). Thus, if the length of the second and/or fourth period of time is too small, then zero-voltage switching is not achieved, which also causes power loss.

FIG. 4 illustrates the effect of the length TDON of the fourth period of time t₃-t₄ (i.e., a deadtime) being too short.

In particular, if the length TDON of the fourth period of time is too short, then switching the first field-effect transistor on will cause a significant voltage jump or step at the FET node x in order to reach the high voltage level HV. Thus, the FET node voltage vx will abruptly change. In other words, hard-switching occurs. This can damage the first field-effect transistor and introduce power loss in the power converter.

More specifically, hard-switching in these circumstances results from the FET node voltage vx not yet being charged, by the collapsing magnetic field about the inductor L, to or near the value of the high voltage level HV.

Similarly, if the length of the second and/or fourth period of time is too large, then the voltage at the FET node x will start to charge/discharge respectively (after reaching the low/high voltage level). This will lead to the voltage at the FET node x moving away from the voltage level to which it will be switched, meaning that zero-voltage level switching is achieved.

FIG. 5 illustrates the effect of the length TDON of the fourth period of time (i.e., a deadtime) being too long.

In particular, if the length TDON of the fourth period of time is too long, then switching the first field-effect transistor on will also cause a significant voltage jump or step at the FET node x, i.e., the FET node voltage vx will abruptly change. In other words, hard-switching occurs. This can damage the first field-effect transistor and introduce power loss in the power converter.

This results from the FET node voltage vx discharging, e.g., as a result of the magnetic field about the inductor L collapsing to the extent that it cannot maintain the charge at the FET node x.

A failure to achieve zero-voltage level switching means that hard-switching will occur. This causes power loss in the power converter as well as causing damage to the transistor.

The present disclosure provides an approach for adaptively controlling the length TDON, TDOFF of the first and/or second period of time. This facilitates the reduction of the amount of dead time, e.g. without causing a loss of zero-voltage switching.

Embodiments also provide techniques for controlling the reactive current in the power converter through controlling the total length TTOTAL of the basic switching sequence. A reduced level of reactive current leads to improved power efficiency of the converter, but is more likely to result in zero voltage switching errors.

The present disclosure proposes approaches for generating and using a first sensing signal. The first sensing signal changes responsive to an average or cumulative length of time that the first or second field-effect transistor conducts when off during a plurality of iterations of the iteratively repeated sequence.

An alternative label for the first sensing signal is a “reverse conduction sensing signal”.

Thus, the first sensing signal represents an average/cumulative amount of time that the first or second field-effect transistor is operating in a reverse conduction state (i.e., conducts in the off-state). This effectively represents the amount of energy that is lost to reverse conduction of one or both of the field-effect transistors.

The control system of the present disclosure is configured to modify the length of the second and/or fourth period of time responsive to the first sensing signal. In particular, the control system may be configured to decrease the length of the second and/or fourth period of time responsive to the average/cumulative amount of time being too high, and increase the length of the second and/or fourth period of time responsive to the average/cumulative amount of time being too low.

This proposed control system thereby effectively controls the length of time for which the field-effect transistors operate in a reverse conduction state. As previously explained, there is a desire to minimize or reduce this length of time (to reduce power loss) without causing other undesirable effects, such as hard-switching.

Thus, the control system may be configured to decrease the length of the second and/or fourth period of time responsive to the first sensing signal indicating that the average or cumulative length of time, that the first or second field-effect transistor conducts when off, is more than a first predetermined length of time.

Similarly, the control system may be configured to increase the length of the second and/or fourth period of time responsive to the first sensing signal indicating that the average or cumulative length of time, that the first or second field-effect transistor conducts when off, is less than a second predetermined length of time.

The first and second predetermined length of time may be the same. Alternatively, the first and second predetermined length of time may be different to provide hysteretic control of the second/fourth period of time.

By way of example, the first predetermined length of time may represent a period of time above which reverse conduction takes place. Similarly, the second predetermined length of time may represent a period of time below which other adverse effects (e.g., hard-switching) occur.

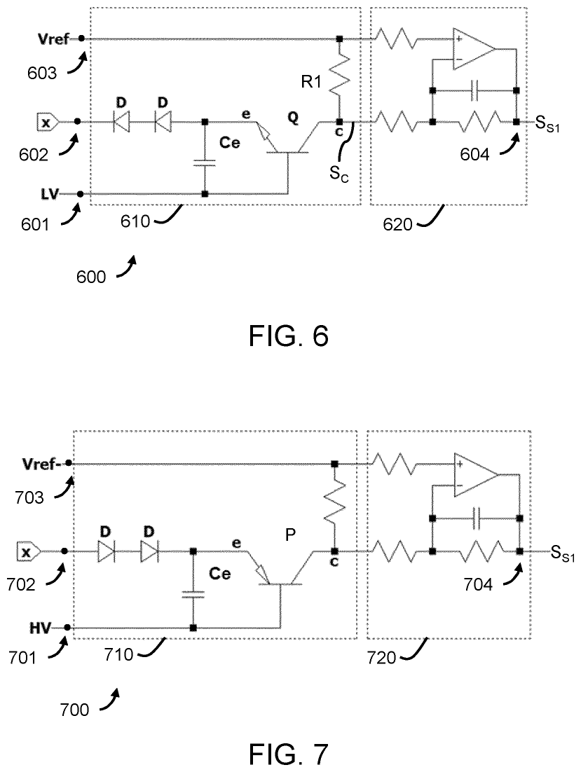

FIG. 6 illustrates an example sensing circuit 600 for determining the average/cumulative amount of time that the first/second field-effect transistor is operating in a reverse conduction state.

More specifically, the sensing circuit 600 produces a first example of a first sensing signal S_{S1} that changes responsive to the average or cumulative length of time, that the second field-effect transistor conducts when off.

The illustrated circuit 600 is here configured to determine the average average/cumulative amount of time that the second field-effect transistor is operating in the reverse conduction state, and could be readily modified for use with the first field-effect transistor.

The circuit 600 comprises a detector portion 610 and a filter portion 620. The detector portion is configured to produce an intermediate signal Sc responsive to reverse conduction of the second field-effect transistor. The filter portion 620 is configured to average or accumulate the intermediate signal to produce the first sensing signal S_{S1}.

The detector portion 610 comprises an NPN bipolar junction transistor (BJT) Q. The base of the NPN BJT is connected to the low voltage level LV. A pair of diodes D connect the emitter of the NPN BJT Q to the FET node x. The pair of diodes may, for instance, be replaced by a single diode (e.g., with a larger conduction threshold voltage or voltage drop) or more than two diodes. A capacitor Ce connects the emitter e of the NPN BJT Q to the base of the NPN BJT Q (i.e., to the low voltage level LV). A resistor R1 connects the collector of the NPN BJT Q to a reference voltage Vref (e.g., ground). The voltage at the collector of the detector portion is the intermediate signal Sc.

The filter portion 620 here comprises an operational amplifier integrator. This effectively produces an average of the voltage at the collector of the NPN BJT, as it provides an output voltage that is proportional to the amplitude and direction of the intermediate signal Sc. The operation and structure of an operational amplifier is well known.

The sensing circuit 600 therefore comprises: a first input node 601 configured to connect to a first voltage level LV; a second input node 602 configured to connect to the FET node x; a third input node 603 configured to connect to a reference voltage level Vref; and an output node 604 for providing the first sensing signal S_{S1}.

The sensing circuit 600 also comprises a transistor Q, comprising a base, emitter and collector. The sensing circuit also comprises one or more diodes D, connected in series and coupled between the emitter e and the second input node 602. A magnitude of a voltage drop across the one or more diodes D is less than a magnitude of a gate threshold of the field-effect transistor. A filtering circuit 620 is coupled between the collector c of the transistor and the output node 604 and configured to generate the first sensing signal S_{S1}.

For the sensing circuit 600, the transistor Q is an NPN BJT.

FIG. 7 illustrates another example sensing circuit 700 for determining the average/cumulative amount of time that the first/second field-effect transistor is operating in a reverse conduction state.

More specifically, the circuit 700 produces a second example of a first sensing signal S_{S1} that changes responsive to the average or cumulative length of time, that the first field-effect transistor conducts when off. This contrasts with the previously described sensing circuit 600 in being designed for the first field-effect transistor.

The circuit 700 comprises a detector portion 710 and a filter portion 720. The filter portion 720 is identical to the previously described filter portion 610. The detector portion differs from the previously described detector portion in that the NPN BJT Q is replaced by a PNP BJT P, with the base thereof being connected to the high voltage HV. The polarity of the diodes D are also reversed.

The sensing circuit 700 therefore comprises: a first input node 701 configured to connect to a second voltage level HV; a second input node 702 configured to connect to the FET node x; a third input node 703 configured to connect to a reference voltage level Vref; and an output node 704 for providing the first sensing signal S_{S1}.

The sensing circuit 700 also comprises a transistor P, comprising a base, emitter and collector. The sensing circuit 700 also comprises one or more diodes D, connected in series and coupled between the second input node 702 and the emitter e. A magnitude of a voltage drop across the one or more diodes D is less than a magnitude of a gate threshold of the field-effect transistor. A filtering circuit 720 is coupled between the collector c of the transistor and the output node 704 and configured to generate the first sensing signal S_{S1}.

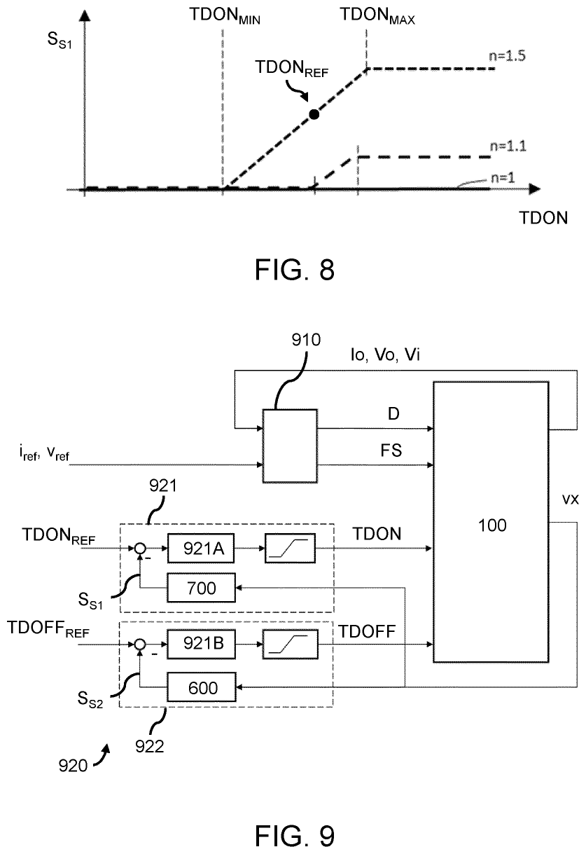

FIG. 8 illustrates the output of the circuit 700, i.e., the magnitude of the sensing signal S_{S1} for different lengths of the fourth period of time TDON. FIG. 8 illustrates the output for different magnitudes of the normalized reactive current n in the converter 100. Thus, FIG. 8 illustrates potential outputs of a sensing circuit for different deadtimes.

FIG. 8 illustrates how the magnitude of the sensing signal S_{S1} increases, from a minimum TDON value TDON_{MIN}, with increasing values of TDON until it reaches a maximum magnitude at a maximum TDON value TDON_{MAX}.

TDON_{MIN} represents the minimum period of time, for the fourth period of time, for which zero voltage switching is maintained. Before this minimum period of time has elapsed, the voltage at the FET node x will not yet have reached the voltage of the voltage level to which it will be switched or connected to.

TDON_{MAX} represents a period of time, for the fourth period of time, after which the voltage at the FET node x will discharge.

It would be preferable to keep the value of TDON between TDON_{MIN} and TDON_{MAX}. This can be achieved by appropriate control of the length of the second time period responsive to the first sensing signal S_{S1}, e.g., by comparing the value of the first sensing signal to predetermined values representing the expected values at TDON_{MIN} and TDON_{MAX}. Alternatively, this can be achieved be comparing the value of the first sensing signal to a reference value TDON_{REF} that corresponds to a position between TDON_{MIN} and TDON_{MAX}.

It will be appreciated that the value of TDON_{MIN}, TDON_{MAX} and TDON_{REF} may depend upon the total amount of reactive current in the circuit. This can be readily calculated for known duty cycles, total length of the basic control sequence and circuit parameters using known approaches.

A similar control scheme can be used to control the length TDOFF of the second period of time.

FIG. 9 illustrates control logic 900 that can be used to control the operation of a converter 100 according to a first embodiment. The control logic 900 can be integrated into the control system 110 illustrated in FIG. 1.

The control logic 900 comprises a current control portion 910 and a deadtime control portion 920.

The current control portion 910 is configured to control an output current iₒ or output voltage vₒ output by the power converter. One way to control the output current (or voltage) is by manipulating the duty cycle D to achieve a desired output current i_{ref} or voltage Vref. The duty cycle D represents the relative length of the first period of time compared to the overall length of the iteratively repeated sequence. Thus, controlling the duty cycle D comprises controlling the length of the first period of time. Increasing the duty cycle D (i.e., increasing the relative length of the first period of time per iterative repetition of the sequence) increase the average voltage output by the converter 100.

The current control portion 910 may also be configured to control the frequency FS (“control frequency FS”) at which the iteratively repeated sequence is repeated, i.e., the length of the iteratively repeated sequence. This will adjust the reactive current. This may, for instance, be performed by explicitly calculating the appropriate switching frequency according to a known mechanism, which typically depends on the operation conditions (Io, Vo, Vi) and circuit parameters.

The deadtime control portion 920 comprises a first deadtime control portion 921 and a second deadtime control portion 922. The first deadtime control portion controls the length of the fourth period of time (i.e., TDON) and the second deadtime control portion controls the length of the second period of time (i.e., TDOFF).

The first deadtime control portion 921 may, for instance, control the length TDON of the fourth period of time to be equal to a reference value TDON_{REF}. The reference value TDON_{REF} may be a value that lies between TDON_{MIN} or TDON_{MAX} previously described.

This can be achieved by producing a first sensing signal S_{S1} that changes responsive to an average or cumulative length of time that the first field-effect transistor is conducting, when off, during a plurality of iterations of the iteratively repeated sequence. This can be performed using the circuit 700 previously described. However, the circuit 700 may be replaced by any other suitable system or circuit that generates such a first sensing signal S_{S1}. The value of the first sensing signal S_{S1} may then be compared to one or more reference values TDON_{REF} and used to control, via feedback circuitry 921A, the length TDON of the second period of time.

Rather than using a single reference value TDON_{REF}, more than one reference value can be used for hysteric control.

The second deadtime control portion 922 may, for instance, control the length TDOFF of the second period of time to be equal to a reference value TDOFF_{REF}.

This can be achieved by producing a second sensing signal S_{S2} that changes responsive to an average or cumulative length of time that the second field-effect transistor is conducting, when off, during a plurality of iterations of the iteratively repeated sequence. This can be performed using the circuit 600 previously described-which produces the second sensing signal rather than a first sensing signal.

The value of the second sensing signal S_{S2} may then be compared to one or more reference values TDOFF_{REF} and used to control, via feedback circuitry 922A, the length TDOFF of the second period of time. Rather than using a single reference value TDOFF_{REF}, more than one reference value can be used for hysteric control.

In a modified version of the control logic 900, one of the first and/or second deadtime control portions 921, 922 can be omitted. In such approaches, the length of the second and fourth periods of times may be controlled to be identical (i.e., TDON=TDOFF). The sensing signal(s) produced can be relabeled appropriately.

As previously mentioned, another controllable parameter that could provide improved power consumption of the converter is the reactive power of the converter. The reactive power can be reduced by decreasing the overall length of time of the iteratively repeated basic control sequence (i.e., increasing the frequency at which the basic control sequence is repeated). This frequency can be labelled the “control frequency FS”.

However, uncontrolled reduction of the reactive power in this way can result in unintended hard-switching. In particular, if the reactive power in the controller is too low, then, during the fourth period of time, the FET node voltage vx will not be able to reach the high voltage level HV before the first field-effect transistor is switched on.

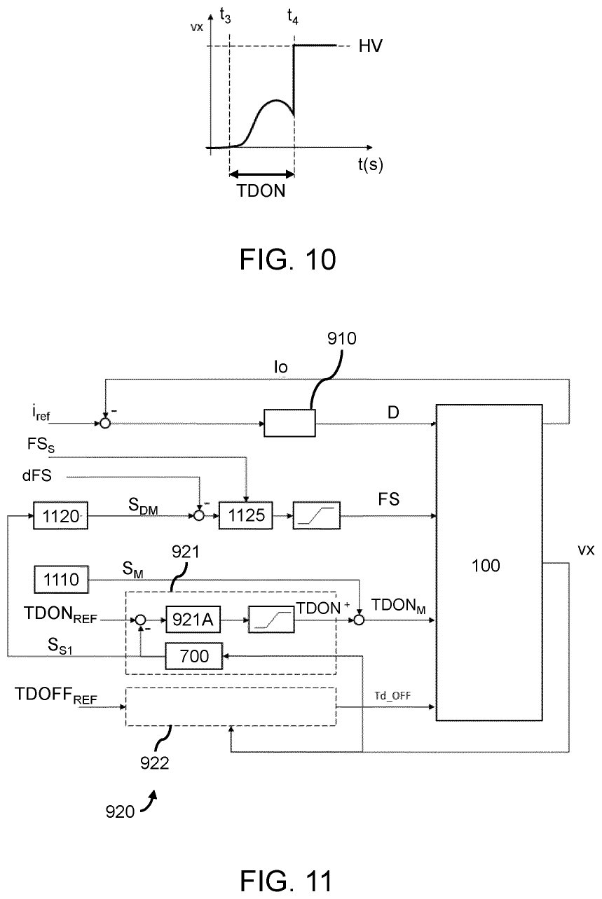

FIG. 10 illustrates the effect of the reactive power being too low, e.g., as a result of the overall length of the basic control sequence being too low. As illustrated, the voltage vx at the FET node x will not reach the high voltage level HV during the fourth period of time t₃-t₄, due to insufficient reactive power in the converter. This causes hard-switching to occur.

It has therefore been recognized that it would be advantageous to provide a mechanism for monitoring the total reactive power in the power converter. This form of feedback can be used to control the overall length of the basic control sequence, i.e., the frequency at which the basic control sequence is repeated. As previously mentioned, this frequency can be known as the “control frequency FS”. Controlling the control frequency FS can be used to reduce the likelihood of the total reactive power in the power converter being too low.

One approach for determining or monitoring the total reactive power in the system is to make use of a hard-switching sensing signal that changes responsive to the presence or absence of hard-switching (of the first and/or second field-effect transistor) throughout a plurality of iterations of the iteratively repeated sequence.

In particular, if hard-switching occurs but there is no/negligible reverse conduction by the first/second field-effect transistor, then this can be indicative that either the total reactive power is too low or that the length of the first/second period of time is too low.

The hard-switching sensing signal is preferably responsive to an average or cumulative size of any voltage steps that occur during switching of the first or second field-effect transistor from off to on or from on to off throughout a plurality of iterations of the iteratively repeated sequence. This facilitates long term control and/or modification of the control sequence, e.g., to reduce or avoid any sudden or reactive changes. However, this is not essential.

A herein proposed control scheme may include decreasing the total length of the iteratively repeated sequence (i.e., increasing the control frequency F_{S}) responsive to the hard-switching sensing signal indicating that the average or cumulative size is less than a first value during the plurality of iterations of the iteratively repeated sequence.

In some instances, a control scheme includes increasing the total length of the iteratively repeated sequence (i.e., decreasing the control frequency F_{S}) responsive to the hard-switching sensing signal indicating that the average or cumulative size is more than a second value during the plurality of iterations of the iteratively repeated sequence. One approach for producing a hard-switching sensing signal comprises introducing a modulation pattern into the control of the length of the fourth period of time. This modifies the sensing signal S_{S1}. (that changes responsive to an average reverse conduction) such that the presence of such a modulation pattern in the first sensing signal indicates that the length TDON of the fourth period of time is between TDON_{MIN} and TDON_{MAX} (i.e., there is no hard-switching). The absence of such a modulation pattern in the first sensing signal indicates that the length TDON of the fourth period of time is not between TDON_{MIN} and TDON_{MAX} (i.e., there is hard-switching).

The presence of the modulation pattern thereby indicates that the control frequency can be increased. The absence of the modulation pattern thereby indicates that the control frequency should be reduced.

Thus, a demodulated version of the first sensing signal can represent the hard-switching sensing signal. The DC component of the first sensing signal (e.g., time-averaged version of the first sensing signal) can be used to control the length of the second/fourth period of time, using any previously descried approach.

A similar technique can be used includes instead introducing a modulation pattern into the control of the length of the second period of time, assuming that a sensing signal is produced that changes responsive to an average or cumulative length of time that the second field-effect transistor conducts when off during a plurality of iterations of the iteratively repeated sequence.

Thus, detection of the modulation pattern (in either the second or fourth period of time, depending upon the embodiment) effectively determines or detects whether or not there is hard-switching.

FIG. 11 illustrates modified control logic 1100 that can be used to control the operation of a converter 1100 according to a second embodiment. The control logic 1100 is similar to the control logic 900, but with additional functionality, namely to include modulation functionality for producing a hard-switching sensing signal.

The control logic 1100 can be integrated into the control system 110 illustrated in FIG. 1.

The control logic 1100 comprises a modulation circuit 1110. The modulation circuit is configured to modulate the length of the fourth period of time according to a modulation pattern, which is carried by a modulation signal S_{M}.

The control logic 1100 also comprises a demodulation circuit 1120. The demodulation circuit processes the reverse conduction sensing signal S_{S1}. (produced by the circuit 700) to produce a demodulation signal S_{DM}, which acts as a hard-switching sensing signal. The demodulation signal indicates the extent to which the reverse conduction sensing signal carries the modulation pattern carried by the modulation signal S_{M}, and thereby the extent of any hard-switching.

As previously explained, the presence of the modulation pattern in the reverse conduction sensing signal S_{S1} indicates that there is no hard-switching. This means that the control frequency FS can be increased. This would lead to a reduction in the reactive current. Otherwise, the control frequency may be reduced, e.g., at a preset rate dFS. Control over the control frequency is performed by a frequency controller 1125. This would lead to an increase in the reactive current.

The frequency controller 1125 may initiate, e.g., at start up, the control frequency FS a start frequency FS_{S}, which can be predetermined and/or responsive to a user input.

The feedback circuitry 921A of the first deadtime control portion 921A may operate as previously explained. More particularly, the feedback circuitry may control the length TDON of the second period of time responsive to the DC component in the reverse conduction sensing signal S_{S1}. The DC component can be extracted using a low-pass filter or any similar technique.

Thus, the controlled length of the second period of time may be equal to a modulated length TDON_{M}.

An alternative hard-switching detection approach, to introducing a modulation pattern in the second and/or fourth period of time, is to make use of a dedicated hard-switching detection circuit. Such a circuit would be configured to monitor for and detect the occurrence of hard-switching in the control of the first and/or second field-effect transistor.

In particular, a hard-switching detection circuit may produce the hard-switching sensing signal. In this approach, the hard-switching sensing signal may be a sensing signal that changes responsive to an average or cumulative size of any voltage steps that occur during switching of the first or second field-effect transistor from off to on or from on to off throughout a plurality of iterations of the iteratively repeated sequence.

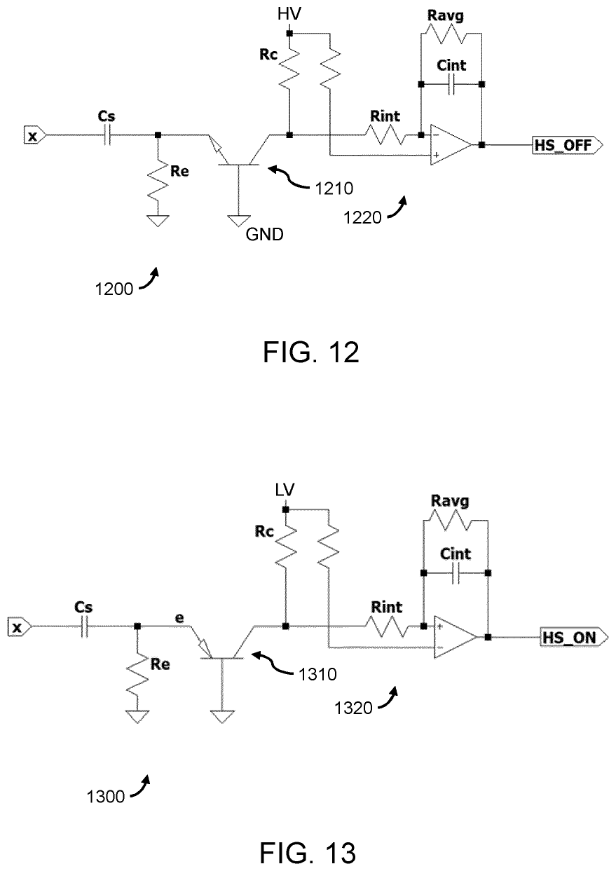

FIG. 12 illustrates a hard-switching detection circuit 1200 that can be used in some embodiments.

The hard-switching detection circuit 1200 is configured to generate a first hard-switching sensing signal HS_OFF that changes responsive to an average of cumulative size of any voltage steps that occur during switching of the first field-effect transistor (during the second period of time).

The hard-switching detection circuit 1200 comprises an input filter Cs, Re and a NPN transistor 120. The input filter Cs, Re is coupled between the emitter is coupled between the emitter of the NPN transistor and the FET node x. The input filter acts to filter any non-voltage steps from signals provided to the NPN transistor. The base of the NPN transistor is connected to a ground GND voltage.

When there is a voltage step at the FET node x, the collector of the NPN transistor 1210 is pulled to the ground GND voltage. This voltage step is not filtered out by the input filter Cs, Re. The difference between the high voltage HV and the amplitude of this voltage step is averaged (over several iterations of the basic control sequence) by averaging circuitry to produce the first hard-switching sensing signal. The operation of the averaging circuitry 1220 is similar to the filter portion of any previously described circuit 600 for determining the average/cumulative amount of time that the first/second field-effect transistor is operating in a reverse conduction state.

FIG. 13 illustrates an alternative hard-switching detection circuit 1300 configured to generate a second hard-switching sensing signal HS_ON that changes responsive to an average of cumulative size of any voltage steps that occur during switching of the second field-effect transistor (during the fourth period of time).

The circuit 1300 is similar to the previously described circuit 1200, excepting that the NPN transistor is replaced with a PNP transistor, and the averaging circuitry 1320 is configured to average the difference between the low voltage LV and the amplitude of the voltage step.

Turning back to FIG. 11, the control logic 1100 can be modified to make use of one or both hard-switching sensing signals produced by omitting any circuitry for modulating and/or demodulating the length of the second period of time. Rather, input to the frequency controller may be a difference between a preset rate dFS and a magnitude of the hard-switching sensing signal HS_ON. This facilitates control over the switching frequency FS without the need for modulation.

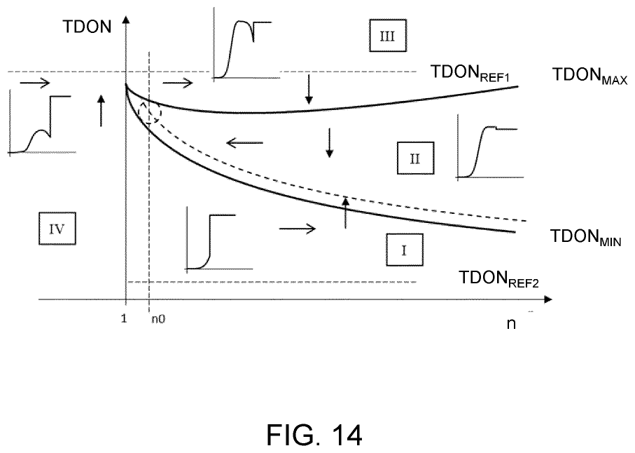

FIG. 14 conceptually illustrates a control strategy for controlling the power converter comprising a first and second field-effect transistor to be synchronously controlled. More particular, FIG. 14 illustrates control steps that can be taken responsive to a reverse conduction sensing signal and a hard-switching sensing signal.

The reverse conduction sensing signal changes responsive to an average or cumulative length of time that the first or second field-effect transistor conducts when off during a plurality of iterations of the iteratively repeated sequence.

The hard-switching sensing signal changes responsive to an average or cumulative size of any voltage steps that occur during switching of the first or second field-effect transistor from off to on or from on to off throughout a plurality of iterations of the iteratively repeated sequence.

More particularly, FIG. 14 illustrates a graph plotting the length TDON of the fourth period of time against the normalized reactive current n (which is inversely related to the switching frequency FS). Four separate areas are labelled I, II, III and IV.

In a first region I, the length TDON of the fourth period of time is insufficient (i.e., less than a minimum length of time TD_{ONMIN}) causing the length of time for which the first field-effect transistor conducts when off to be below a desired length of time. The length TDON should therefore be increased. This is detected using the (amplitude of) the reverse conduction sensing signal and controlled appropriately.

In the first region I, the control frequency may also be reduced (to increase the normalized reactive current). This may be performed because hard-switching is detected (as a result of the length TDON being insufficient).

In a second region II, the length TDON of the fourth period of time is sufficient and there is no hard-switching. The total reactive current can thereby be reduced, e.g., by increasing the control frequency. The length TDON does not need to be changed.

In a third region III, the length TDON of the fourth period of time is too long, resulting in hard-switching. In particular, this causes the length of time for which the first field-effect transistor conducts when off to be above a desired length of time. The length of the fourth period of time is therefore reduced. As hard-switching occurs, the control frequency may be decreased to increase the normalized reactive current.

In a fourth region IV, the normalized reactive current is too low, resulting in hard-switching. The control frequency may therefore be decreased to increase the normalized reactive current. In the fourth region, it is also perceived that the length of time for which the first field-effect transistor conducts when off is below a desired length of time. The length TDON may therefore be increased.

Thus, the actions taken when in the first region I and the fourth region IV may be the same.

When controlling the length TDON of the fourth period of time, there may be maximum allowable and minimum allowable values for the length TDON of the fourth period of time. A maximum value may be a first reference value TDON_{REF1}, and a minimum value may be a second reference value TDON_{REF2}. These values may be selected or chosen responsive to the precise circuitry of the power converter.

Proposed embodiments make use of a control system for controlling the operation of field-effect transistors. The skilled person would be readily capable of designing and/or creating circuitry for a suitable control system that follows herein proposed techniques and strategies. Suitable examples may include processing circuitry, e.g., microprocessors, fixed-function hardware, field programmable gate arrays (FPGAs) and/or application-specific integrated circuits (ASICs). The precise construction or formation of the control system is not essential to achieve the underlying concept herein proposed.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa.

Any reference signs in the claims should not be construed as limiting the scope.

1. A control system for a power converter comprising a first and second field-effect transistor to be synchronously controlled, wherein the control system is configured to:
control the switching of the first and second field-effect transistors according to an iteratively repeated sequence comprising:
a first period of time, during which the first field-effect transistor is on, and the second field-effect transistor is off;
a second period of time, during which the first field-effect transistor is off, and the second field-effect transistor is off;
a third period of time, during which the first field-effect transistor is off, and the second field-effect transistor is on; and
a fourth period of time during which the first field-effect transistor is off, and the second field-effect transistor is off;
receive a first sensing signal, being a sensing signal that changes responsive to an average or cumulative length of time that the first or second field-effect transistor conducts when off during a plurality of iterations of the iteratively repeated sequence,
modify the length of the second and/or fourth period of time responsive to the first sensing signal, wherein:
the first sensing signal is a sensing signal that changes responsive to an average or cumulative length of time that the first field-effect transistor conducts when off during a plurality of iterations of the iteratively repeated sequence;
the iteratively repeated sequence comprises, during the fourth period of time modulating the length of the fourth period of time according to a modulation pattern; and
the control system is further configured to;
perform a demodulation procedure on the first sensing signal to determine whether or not the first sensing signal carries the modulation pattern; and
control the total length of the iteratively repeated sequence responsive to whether or not the first sensing signal carries the modulation pattern.

2. A control system for a power converter comprising a first and second field-effect transistor to be synchronously controlled, wherein the control system is configured to:
control the switching of the first and second field-effect transistors according to an iteratively repeated sequence comprising:
a first period of time, during which the first field-effect transistor is on, and the second field-effect transistor is off;
a second period of time, during which the first field-effect transistor is off, and the second field-effect transistor is off;
a third period of time, during which the first field-effect transistor is off, and the second field-effect transistor is on; and
a fourth period of time during which the first field-effect transistor is off, and the second field-effect transistor is off;
receive a first sensing signal, being a sensing signal that changes responsive to an average or cumulative length of time that the first or second field-effect transistor conducts when off during a plurality of iterations of the iteratively repeated sequence,
modify the length of the second and/or fourth period of time responsive to the first sensing signal, wherein the control system is further configured to:
receive a third sensing signal, being a sensing signal that changes responsive to an average or cumulative size of any voltage steps that occur during switching of the first or second field-effect transistor from off to on or from on to off throughout a plurality of iterations of the iteratively repeated sequence; and
modify the total length of the iteratively repeated sequence responsive to the third sensing signal.

3. The control system according to claim 1, wherein the control system is configured to decrease the length of the second and/or fourth period of time responsive to the first sensing signal indicating that the average or cumulative length of time, that the first or second field-effect transistor conducts when off, is more than a first predetermined length of time.

4. The control system according to claim 1, wherein the control system is configured to increase the length of the second and/or fourth period of time responsive to the first sensing signal indicating that the average or cumulative length of time, that the first or second field-effect transistor conducts when off, is less than a second predetermined length of time.

5. The control system of claim 1, wherein the control system is configured to decrease the total length of the iteratively repeated sequence responsive to the demodulation procedure determining that the first sensing signal carries the modulation signal.

6. The control system of claim 1, wherein the control system is configured to increase the total length of the iteratively repeated sequence responsive to the demodulation procedure determining that the first sensing signal does not carry the modulation signal.

7. The control system of claim 1, wherein:
the first sensing signal is a sensing signal that changes responsive to an average or cumulative length of time that the second field-effect transistor is conducting, when off, during a plurality of iterations of the iteratively repeated sequence; and
the control system is configured to modify the length of the second period of time responsive to the first sensing signal.

8. The control system of claim 7, wherein the control system is further configured to:
receive a second sensing signal, being a sensing signal that changes responsive to an average or cumulative length of time that the second field-effect transistor is conducting, when off, during a plurality of iterations of the iteratively repeated sequence; and
the control system is configured to modify the length of the second period of time responsive to the second sensing signal.

9. The control system of claim 2, wherein the control system is configured to decrease the total length of the iteratively repeated sequence responsive to the third sensing signal indicating that the average or cumulative size is less than a first value during the plurality of iterations of the iteratively repeated sequence.

10. The control system of claim 2, wherein the control system is configured to increase the total length of the iteratively repeated sequence responsive to the third sensing signal indicating that the average or cumulative size is more than a second value during the plurality of iterations of the iteratively repeated sequence.

11. The control circuit according to claim 1 comprising a sensing circuit for determining an average or cumulative length of time that a field-effect transistor is conducting when off, the field-effect transistor being coupled between a first voltage level and an FET node, the sensing circuit comprising:
a first input node configured to connect to the first voltage level;
a second input node configured to connect to the FET node;
a third input node configured to connect to a reference voltage level;
an output node for providing a first sensing signal for indicating the average or cumulative length of time that the field-effect transistor is conducting when off;
a transistor, comprising a base, emitter and collector;
one or more diodes, connected in series and coupled between the emitter and the second input node, wherein a magnitude of a voltage drop across the one or more diodes is less than a magnitude of a gate threshold of the field-effect transistor; and
an filtering circuit coupled between the collector of the transistor and the output node and configured to generate the first sensing signal by averaging and/or filtering the signal at the collector of the transistor.

12. The control circuit of claim 11, wherein:
a predefined voltage level is a high voltage level; and
the transistor is a PNP transistor.

13. The control circuit of claim 12, wherein, each of the one or more diodes is connected so that current is able to flow from the second input node to the emitter.

14. A lighting system comprising:
a power converter;
a control circuit according to claim 1 for controlling the power converter;
a lighting load, arranged to receive power from the power converter.
